(19) United States
(12) Patent Application Publication
(10) Pub. No.: US 2007/0290888 A1
(43) Pub. Date: Dec. 20, 2007

(54) System and method to facilitate parking

(76) Inventors: Roberto Reif, Brighton, MA (US); Kenneth Arders Halvorsen, Natick, MA (US); Andrew P. Golden, Jamaica Plain, MA (US)

Correspondence Address: Andrew P. Golden, #7, 49 South Street, Jamaica Plain, MA, 02130, US

(21) Appl. No.: 11/820,217

(22) Filed: Jun. 18, 2007

Related U.S. Application Data
(60) Provisional application No. 60/814,428, filed on Jun. 19, 2006.

(51) Int. Cl. G08G 1/14

(52) U.S. Cl. 340/932.2

(57) ABSTRACT

This invention comprises a method and system for facilitating the usage of parking spots and providing offers to parkers. A request to identify at least one parking spot is received. At least one offer for a parker is selected. An indication of the at least one offer is provided.

### CROSS-REFERENCE TO RELATED APPLICATIONS

This application hereby claims priority from U.S. Provisional Application Ser. No. 60/814,428 filed Jun. 19, 2006, entitled “SYSTEM AND METHOD TO FACILITATE PARKING,” the entirety of which is incorporated herein by reference for all purposes.

### FIELD OF THE INVENTION

The present invention relates to methods and apparatus to facilitate parking in urban areas. More specifically, the invention relates to methods to optimize the matching of parking spots with parkers who need them and the marketing opportunities that arise from the match.

### 1.0 BACKGROUND OF THE INVENTION

There is a need for parking spots in urban areas that are convenient and inexpensive.
Parking a car in many cities is a frustrating adventure due to the scarcity of public parking and the high cost of garages. For example, in Boston over 5,000 parking violations are issued per day on average, which indicates not the number of people illegally parked but the number who got caught. It is no great leap to assume that tens of thousands of people illegally park each day in Boston, assuming the risk of getting a parking ticket. According to the City of Boston's transportation department, “the demand for convenient and affordable parking . . . far exceeds the supply” and “with auto registrations in Boston up 36% since 1990, this parking scarcity will undoubtedly continue”.
Although public parking (e.g. meters, residential parking, unmetered parking spots, and illegal parking spots) is inexpensive, it is inconvenient because the supply of parking spots is too low. Finding a parking spot typically requires time, luck, spare change, and/or the risk of an expensive parking ticket or towing. Parking garages may be more convenient in that available parking spots may be easier to find, but the cost of such a parking spot is significantly higher.
Parking broker systems exist in some cities, which allow those in need of parking (i.e. parkers) to access the inventory of one or more parking garages online. (e.g. http://www.airportparkingreservations.com/; e.g. http://www.theparkingspot.com/; e.g. http://www.airport-parking.co.uk/; http://www.airport-parking-shop.co.uk/) However, parkers are limited to parking at the specific locations where the garages are located and prices are too high for many parkers.

There is a need for a convenient/hassle free means for owners of parking spots to earn cash when their parking spots are empty.
Imperial Parking Canada Corporation (http://lots.impark.com/London/) allows owners to rent out unused parking spots. However, owners have no control or flexibility over the times or dates at which the parking spots are rented. Thus, owners who have parking spots that are often but not always available can not participate (e.g. owner uses parking spot at night, but parking spot is vacant 50 hours per week because owner drives to work).
According to a public radio news report, “One new service called SpotScout will allow people to swap parking spaces in a real-time trade that's like an eBay auction. It's coming to New York and five other cities this spring . . . ” (http://www.uli.org/AM/Template.cfm?Section=Home&CONTENTID=16590&T EMPLATE=/CM/ContentDisplay.cfm). However, requiring all parkers to also provide parking spots for other parkers in the network is complicated and it precludes parkers who don't own rentable parking spots. Furthermore, requiring a parker to win an auction for a particular parking spot is complicated, inconvenient, and it precludes parkers who need immediate parking or don't have time to serially enter and follow several auctions until winning a parking spot.

There is a need for businesses to reach parkers
Parkers are often unfamiliar with neighborhoods to which they travel, and they may be unaware of local businesses (e.g. where can one get coffee or lunch before a meeting?). A familiarity with selected local businesses may encourage parkers to shop or run errands while in that neighborhood, which also benefits the local businesses.

### 2.0 TERMS

Parker—A person or entity that desires to use a parking spot.

Owner—A person or entity that owns, manages, or otherwise controls one or more parking spots that may be available for use by parkers. Owner may be one or more private individuals or corporate entities.

Central Server—An entity that may facilitate the exchange of parking space rental for a parker in exchange for compensation for an owner.

Timerange—a set of one or more time blocks during which an owner indicates that a parking spot is available for rent. The set of time blocks may be continuous or not, on one or more dates. The timerange may be of arbitrary time length. For example: 8 AM-11:30 AM tomorrow, 1 PM-2 PM every Thursday and Friday of July 2007, 57 minutes anytime between 9 AM and 5 PM today.

Reservation time—the time span, over one or more dates, at which a parker has been granted use of one or more parking spots.

Offer—information provided to a parker about a business. The information may comprise an advertisement about the business, or a benefit that may be provided to or earned by a parker.

Parking Garage—A place where one or more cars may be parked. The parking garage may be covered or uncovered, outdoors or indoors, secured or unsecured.

### 3.0 SUMMARY OF THE INVENTION

In one embodiment of the invention, a timerange is received and the timerange may be associated with a parking spot of an owner. An indication that a parker is interested in reserving at least one parking spot may be received. The at least one parking spot may be reserved.

In another embodiment an indication may be received that a parker may be interested in reserving at least one parking spot. An offer may be selected and the offer may be provided to the parker.

In yet another embodiment, a central server receives a request from an owner to post an available parking spot. The request to post may comprise a timerange of availability for the parking spot. The central server receives a second request from a parker to search for one or more available parking spots. The request to search may comprise a desired reservation time, as well as a location, during which the one or more available parking spots are desired. Based on the request to search, the central server may provide an indication of the owner's posted parking spot to the parker. The central server receives a request from the parker to reserve the parking spot in one embodiment. Information associated with the reservation of the parker may be used in selecting an offer to provide to the parker. Financial compensation may be transferred from the parker to the owner and the reservation may be completed.

### EXAMPLE 1 WEB BASED PARKING SPOT RENTAL

An owner of a parking spot provides a first username and a first password in order to log into a website associated with the central server. Information (e.g. a financial account identifier, email address, and digital picture of parking spot) may be stored in a database of the central server in association with the username and password. The central server receives a first request from the owner to post a parking spot. The post comprises:
Timerange: Parking spot available from Monday through Friday, 9 AM-5 PM, all of June-August 2007, except July 17-19
Location is 15 Elm Street, Allston, Mass. 99999
Price=$2/hour
Digital picture of parking spot is uploaded

A parker provides a second username and password to log into the website. Information (e.g. a financial account identifier, license plate number, make/model/color of car, email address) may be associated with the username and password of the parker. The central server receives a second request from the parker to search for an available parking spot. The search comprises:
Parking spot location: within 2 blocks of 39 Thorndike Street
Reservation time: Every M, W, F from 9 AM-1 PM during June

Based on a search of a database, the central server determines and provides information describing 12 postings that fit the search criteria. The information comprises parking spot locations, maps of the neighborhoods, driving directions from the parker's originating location (e.g. home address), digital pictures of the parking spots, the price of each parking spot, and the size of each parking spot. The parker selects the posting of the owner with a parking spot at 15 Elm Street. The central server reserves the owner's parking spot for the parker, based on a request received from the parker. Financial compensation for the parking spot is transferred from the parker's financial account to the owner's financial account. The central server provides the owner with an email confirmation or receipt that describes the reservation time, username and email address of the parker, license plate number/make/model/color of car of parker, and compensation. The parker receives a confirmation email that serves as a receipt. The email comprises the username and email address of the owner, the location, a map of the neighborhood, directions to the parking spot from the parker's home address, a digital photo of the parking spot, size of the parking spot, and phone numbers at which assistance is available (e.g. parker can't locate parking spot).

### EXAMPLE 2 OFFER IS PROVIDED TO PARKER

Same as EXAMPLE 1, except that an offer (refer to section 5.5.1) is provided to the parker. In particular, the central server stores the geographic location, target market, and offer in a database. After the central server receives a request to reserve a parking spot at 15 Elm Street, Cambridge, Mass. from 9 AM-1 PM every Monday, Wednesday, and Friday during June, the central server searches for local businesses. Lindsey's Muffin Shop offers free coffee with the purchase of any muffin and the presentation of a coupon (muffin.jpg), which is to be provided to parkers in a confirmation email. In addition, $0.05 will be transferred to the central server from Lindsey's Muffin Shop's financial account for every confirmation email that includes the coupon. This offer is selected and provided to the parker in the email confirmation, because 15 Elm Street is 2 blocks away.

### EXAMPLE 3 CELL PHONE BASED PARKING RENTAL

The central server receives a text message from a parker, which indicates a parking spot is needed immediately, for 2 hours, for a price under $3/hour, within 4 blocks of 113 Charles Ave, Boston. The central server identifies the parker's username and associated personal information from the parker's cell phone number. The central server identifies an available parking spot and reserves the parking spot for the parker. The central server provides an address and an interactive map (e.g. courtesy of Google™) to the parking spot for the parker via the parker's cell phone. Financial compensation for the parking spot is automatically transferred from the parker's financial account—85% is transferred to the owner, and 15% is transferred to the central server's financial account.

### 4.0 BRIEF DESCRIPTION OF THE DRAWINGS

It is envisioned that this invention may be enabled in a variety of ways. For example, the invention may be practiced with or without computers. One exemplary system for enabling the invention is presented in FIGS. 1-10.

FIG. 1 is a flow chart that describes one embodiment of the invention

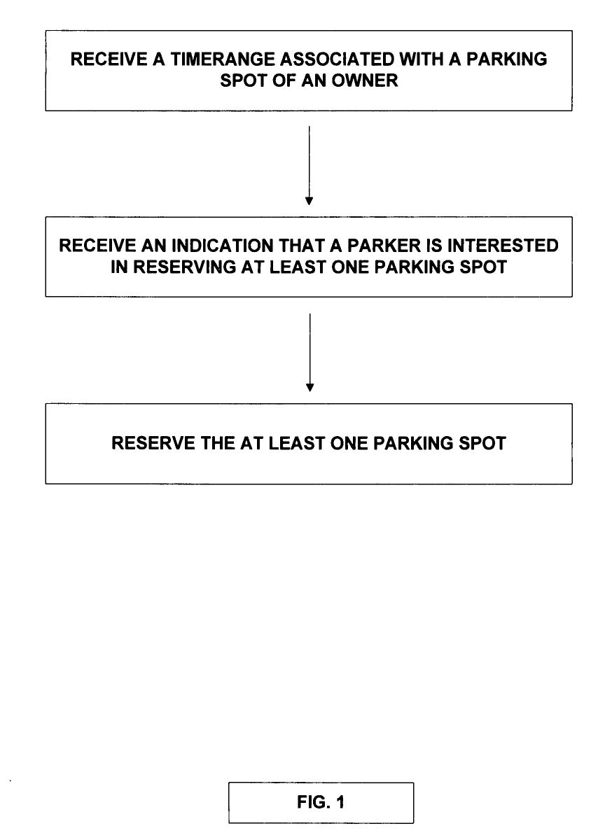

FIG. 2 is a flow chart that describes one embodiment of the invention

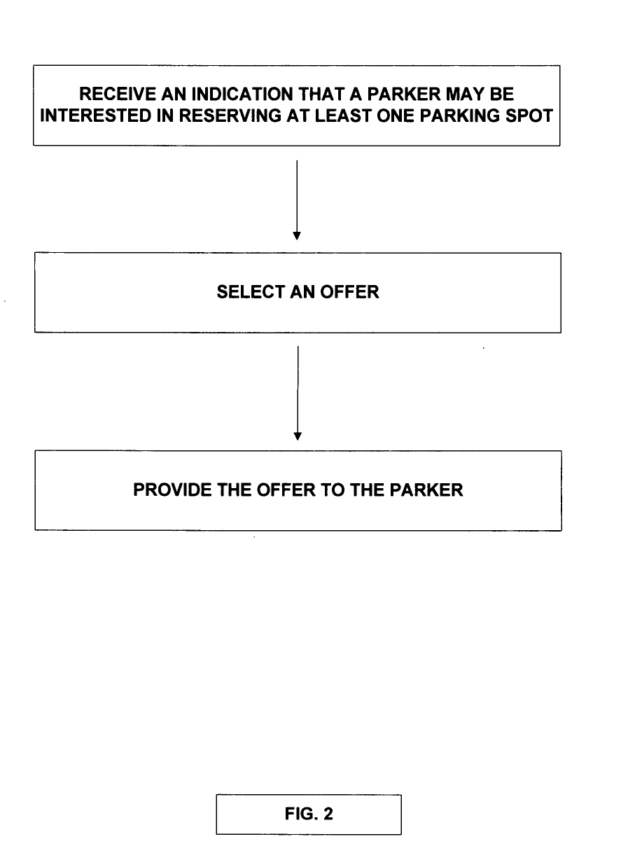

FIG. 3 describes an exemplary graphical user interface that may be provided to parkers, owners, and/or other users who accessing the home page of a parking Web Site.

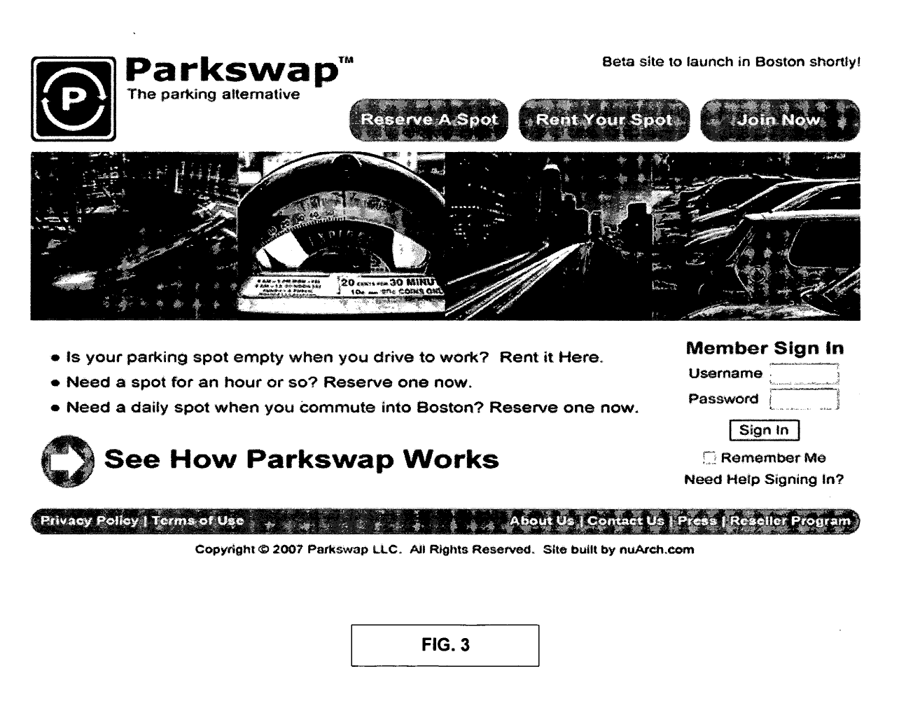

FIG. 4 describes an exemplary graphical user interface that may be provided to owners and/or other users so that the central server may receive a timerange associated with a parking spot of an owner.

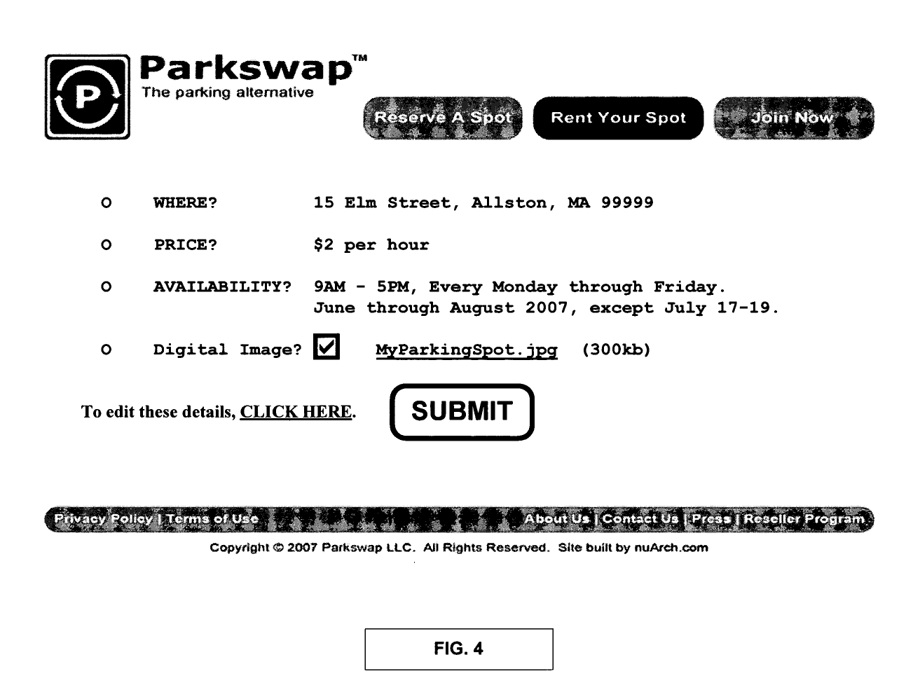

FIG. 5 describes an exemplary graphical user interface that may be provided to parkers and/or other users so that the central server may provide a list of available parking spots to a parker.

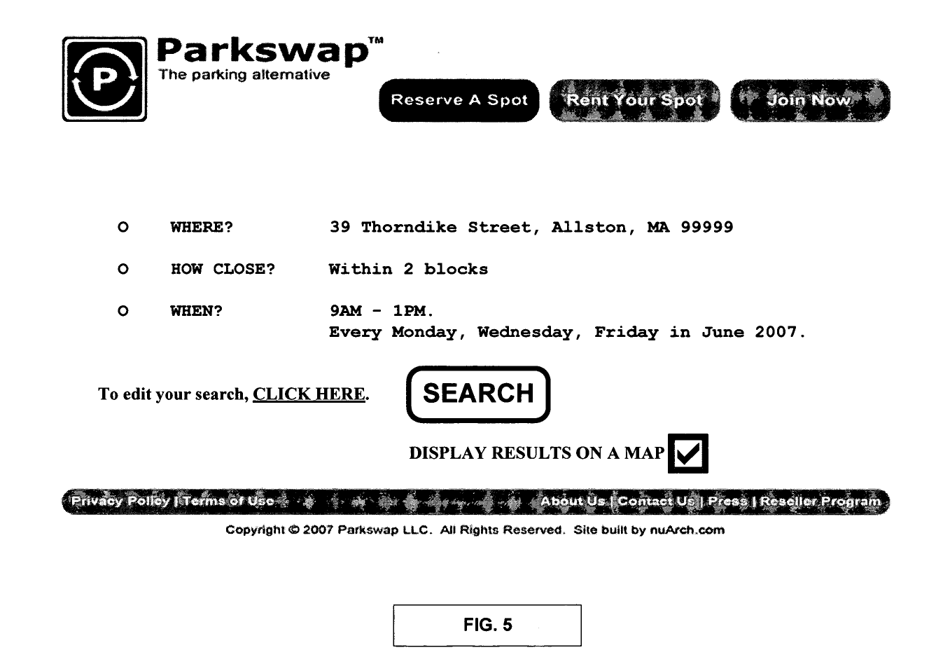

FIG. 6 describes an exemplary graphical user interface that may be provided to a parker in an E-mail, in order to provide details associated with a reservation and one or more offers to the parker.

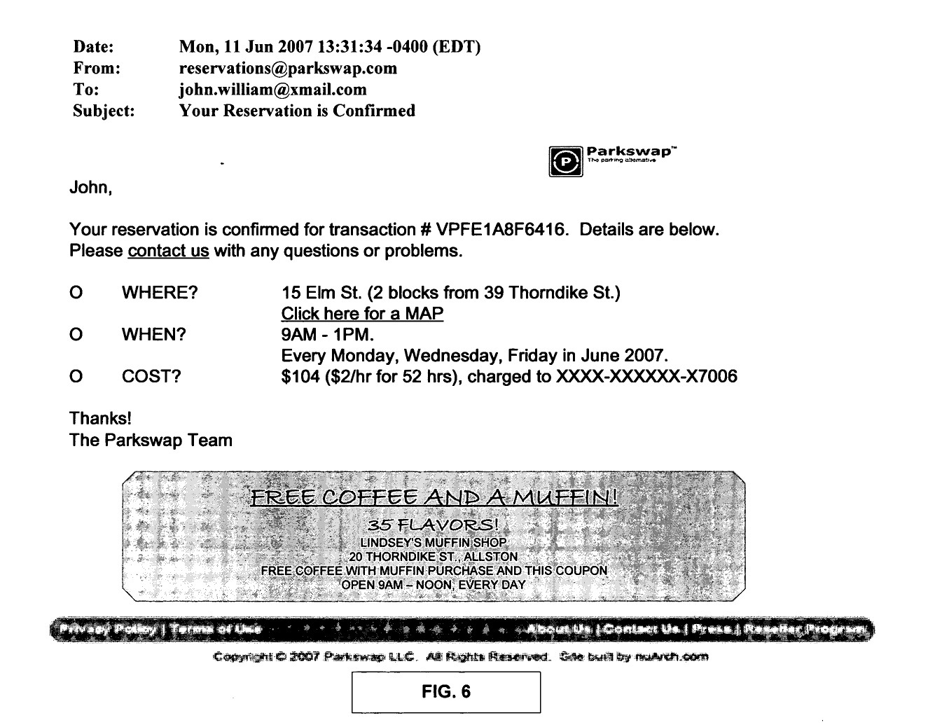

FIG. 7 is a general overview of the system. Note that the invention may be enabled with or without the use of computers or electronic equipment. For example, one or more parties may communicate via electronic or non-electronic means. Furthermore, if particular tasks are automated or performed electronically, they may be enabled via software or hardware. In the particular embodiment described in FIG. 3, Parker Device 1 may be a wireless device (e.g. cell phone; communication via voice or text). Parker Device 2 may be a computer or other wired device. Parker Device 3 may be a home telephone. The Third Party Device and Owner Device may be computers. A device may be used for more than one purpose (e.g. Owner Device may sometimes be used as a parker device to rent other parking spots)

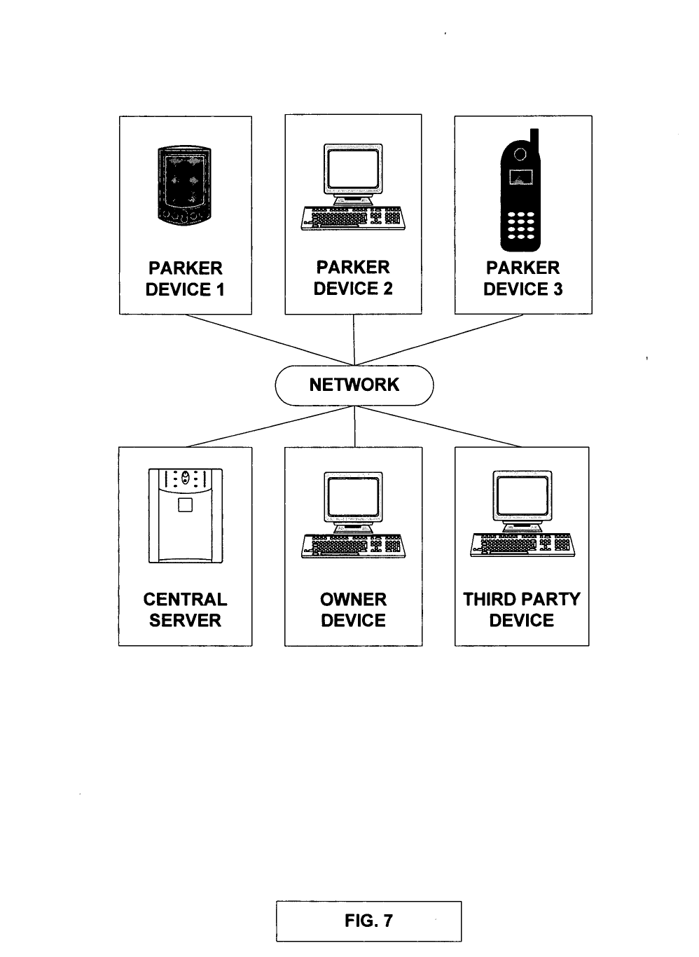

FIG. 8 describes the central server

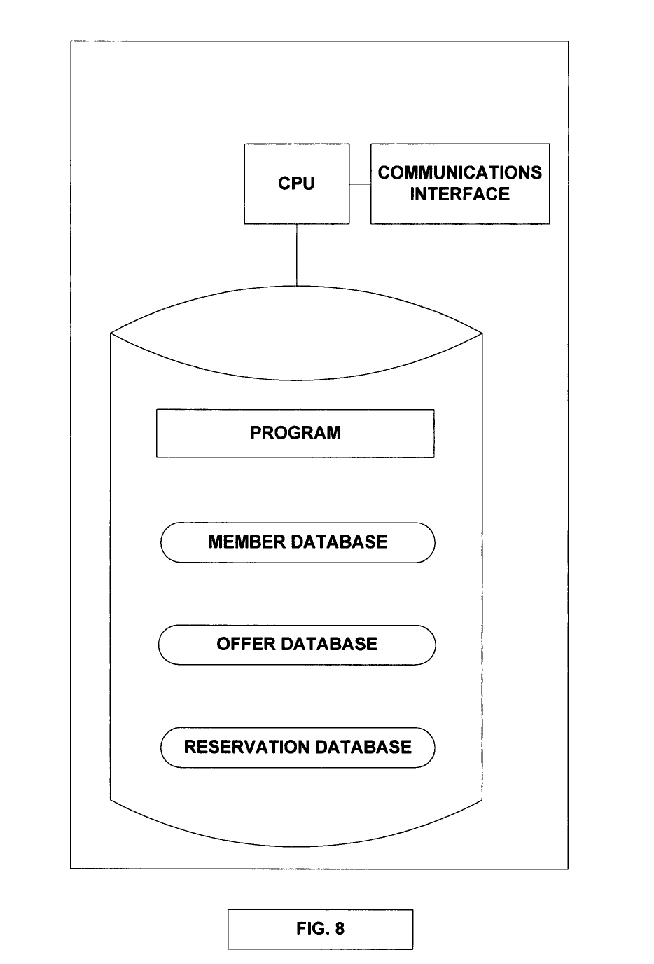

FIG. 9 describes the member database of the central server, which may includes potential and practicing parkers and owners.

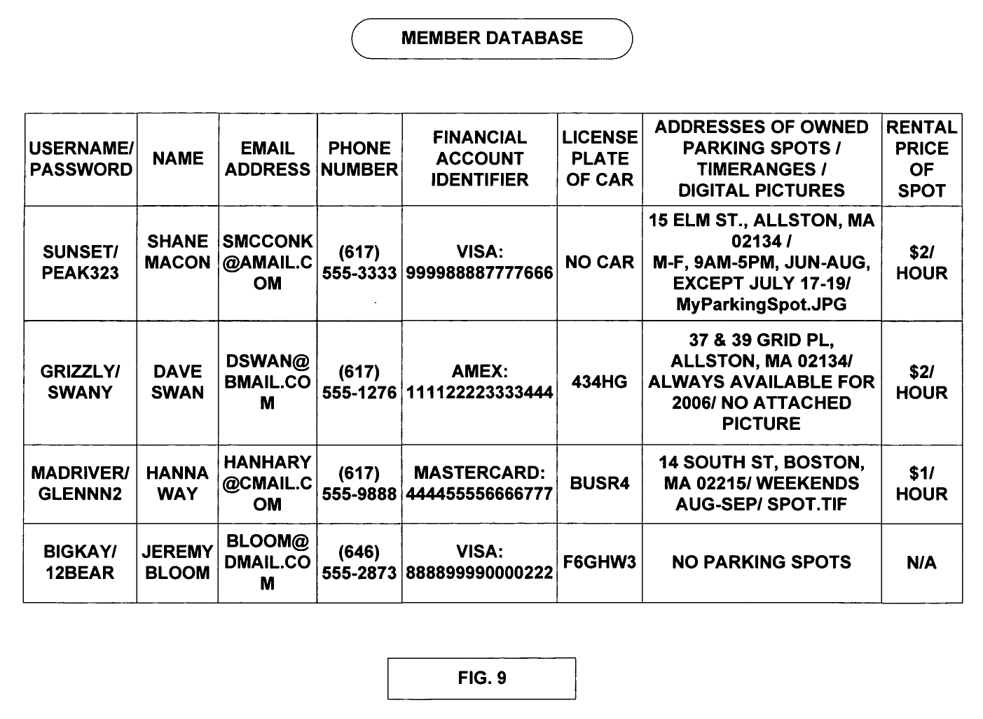

FIG. 10 describes the offer database of the central server, which may comprise information associated with third parties and the offers that may be presented.

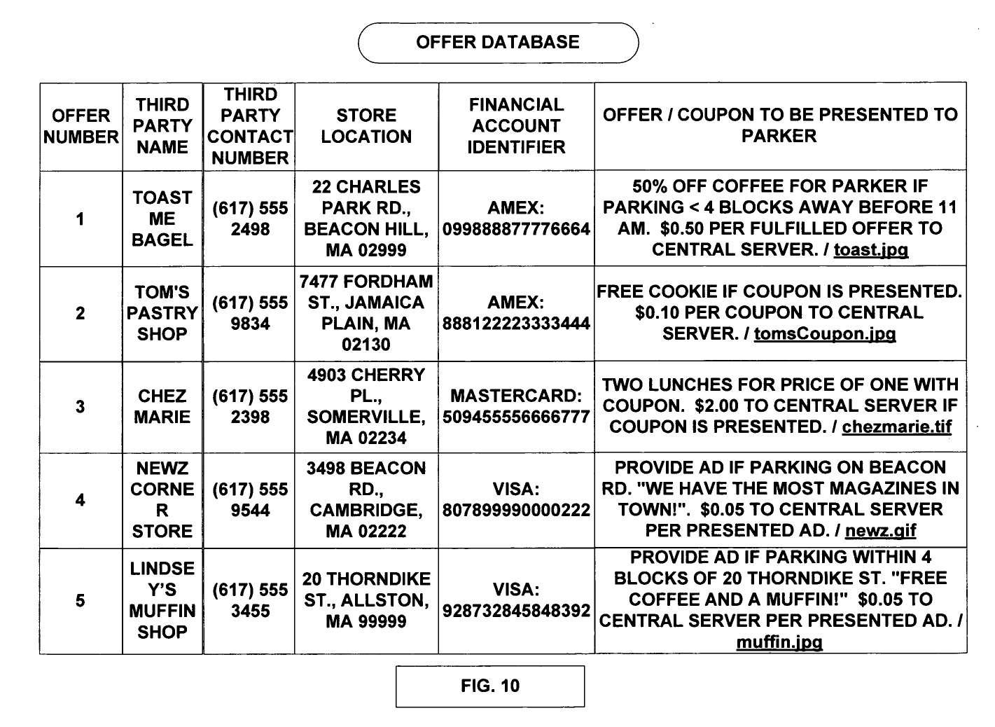

FIG. 11 describes the reservation database of the central server, which may comprise information associated with each transaction, such as details of the reservation and the offer provided to the parker.

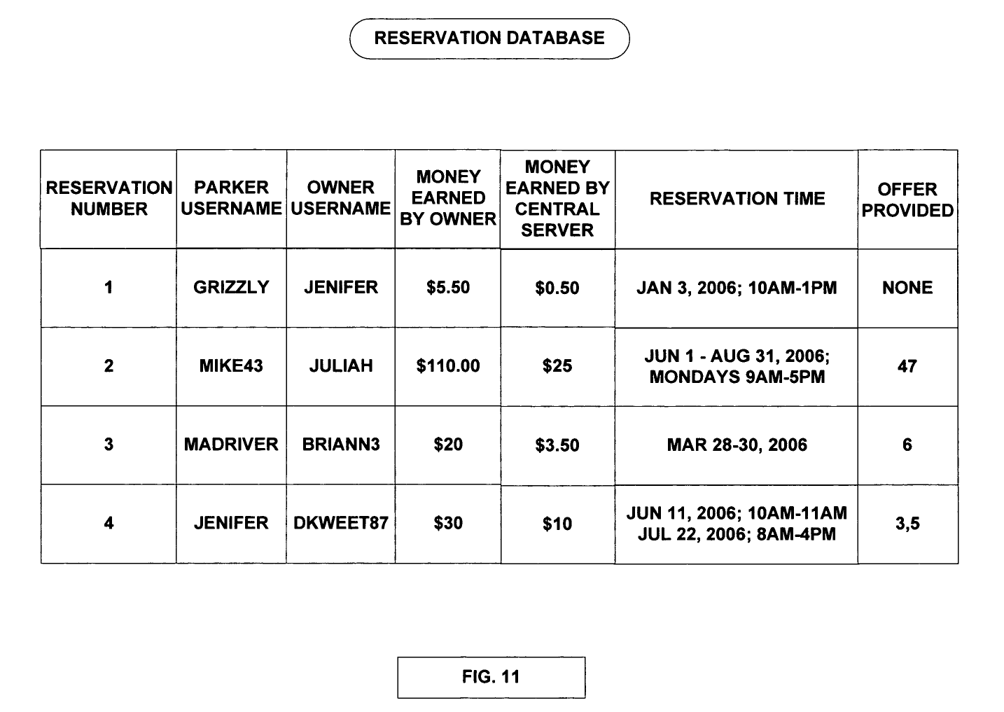

### 5.0 BENEFITS OF THE INVENTION

Third Parties:
Offers attract customers to businesses (i.e. to third parties).
Offers can be targeted to customers based on information associated with them and/or their reservation

Parkers:
Offers provide valuable offers to parkers who may not be familiar with a neighborhood and local businesses
Privately owned parking spots, which were previously unavailable, represent a new supply of parking spots.
Convenient for parkers who need immediate parking
Convenient for parkers who plan ahead and want to avoid the frustrations of finding public parking and reserving a parking spot in advance
The addition of an offer-based revenue stream may offset costs and reduce or eliminate fees paid by parkers and owners for the service

Owners:
The addition of an offer-based revenue stream may offset costs and reduce or eliminate fees paid by parkers and owners for the service
Provides a hassle-free cash flow to owners whose parking spots are not always occupied.

City:
Decreases traffic significantly by decreasing the percentage of drivers who are searching for public parking spots.

### 6.0 DETAILED DESCRIPTION OF THE INVENTION

### 6.1 Initiate Membership for a Potential Owner and/or Parker

A potential owner and/or parker may connect to a parking Web Site and then create a user profile with the central server, in one embodiment. The user profile may comprise:
Name
Email address, phone number, and home address
Financial account (facilitating transfer of funds)
License plate number, make/model/color of car, and driver's license number (for parker)

An owner may or may not also participate by renting parking spots from other owners. In other words, a parker may or may not also participate as an owner.

In one embodiment, the owner may actually be affiliated with the central server. For example, the company that operates the central server may not only connect owners with parkers, but may also offer its own parking spots for reservation by parkers.

### 6.2 Receive Request to Post Available Parking Spot from an Owner

A post may comprise:
Location of parking spot
Timerange of parking spot
   Owner may allow parkers to reserve for any reservation time within this timerange, or owner may restrict reservations to parkers who commit to a significant percentage of the timerange (e.g. 2 hours over 6 months vs. 40 hours/week, every week over 6 months)
Price of renting parking spot
   Price can be constant ($2/hour) or variable (e.g. $2/hour on weekdays, $1/hour on weekends, $20/hour if Red Sox game or concert/event at Fenway Park)
Digital picture
Size of parking spot
Whether parking spot risks coverage with snow in the event of snowfall
Minimum member rating of parker who can use parking spot (refer to alternative ideas section)
Safety of neighborhood
Type of parking spot (e.g. indoor, outdoor driveway, outdoor parking lot)

The owner may post one or more parking spots.

The price of parking spots may be set, partially influenced, or uncontrolled (e.g. seller sets price) by the central server.

Some of the information that is required from the owner to post a parking spot may be saved or determined by the central server from information provided during membership initiation (e.g. location, safety, size of parking spot). This may improve convenience for the owner by reducing the amount of time it takes to post a parking spot.

The owner and central server may communicate via any known means of communication. For example:
Internet (e.g. via a graphical user interface on a website)
Telephone; landline or cell phone (e.g. via call center or voice recognition software)
Other wireless communication means (e.g. text message)
Fax

### 6.3 Receive Request from Parker to Search for a Parking Spot

The parker may be identified (e.g. by a cell phone number or a username and password).

The parker and central server may communicate via any known means of communication. For example:
Internet (e.g. via a graphical user interface on a website)
Telephone; landline or cell phone (e.g. via call center or voice recognition software)
Other wireless communication means (e.g. text message)
Fax
Other wired or non-electronic communication

Parking search may be focused or limited by a search filter that is based on one or more of the following:
Reservation time during which parker desires to rent parking spot
   Reservation time may begin immediately or may be in future.
   Reservation time may be one continuous range or several discontinuous ranges.
Location (e.g. address of parker's destination, neighborhoods which would be acceptable to park in).
Price range
Payment method (e.g. Visa, Credit card number, expiration date)
Size of parking spot
If it snows, will parking spot by plowed?
Safety of neighborhood
Member rating of owner
Other parking spot characteristics

In one embodiment, the parker may pre-register with the central server for convenience. Some information of the request for parking may be associated with the parker during membership initiation (e.g. location, safety, size of parking spot, etc.).

In another embodiment, information associated with the request may be automatically determined without direct input from the parker. Technological enhancements like a global positioning system (GPS) or cell phones may be employed to automatically identify appropriate parking spots for parkers who need to park immediately (e.g. a GPS incorporated into the parker's cell phone determines the parker's current location, and the central server locates parking in this location) and/or to more easily provide directions to parkers who are lost.

A parker may search for one or for multiple parking spots for multiple cars (e.g. a college sports team needs parking for 5 cars in Cambridge), or may search for multiple parking spots to fulfill a reservation time for one car (e.g. park at 15 South Street on Monday, Wednesday, and Friday, but park at 39 South Street on Tuesday and Thursday).

### 6.4 Provide Indication of the Available Parking Spot to Parker

In one embodiment, one or more available parking spots may be provided to the parker by the central server. The parker may refine or modify a search filter to narrow or refocus a search. Then, the central server may provide a second indication of posted available parking spots to parker. Upon finding a suitable parking spot from the set of available parking spots, the parker may request a reservation for the parking spot.

In another embodiment, the central server automatically selects an available parking spot for the parker.

### 6.5 Book the Reservation

The central server books the reservation. The reservation may span all or only a portion of the timerange of availability of the parking spot. The reservation time associated with the reservation is rendered unavailable for the reserved parking spot. Financial compensation may be transferred to the owner from the parker (or from the central server, but on behalf of the parker).

In one embodiment a receipt or reminder of the reservation may be provided to the owner and/or the parker.

For example, an indication on an owner's personal member webpage or an email confirmation may be automatically sent to the owner, which comprises:
User name, phone number and/or email address of parker
License plate number, make, model, and color of parker's car
Reservation time during which parker has reserved parking spot
Phone number of a call center that may help mediate potential problems
Amount of financial compensation due to the owner

Also, for example, an email confirmation, or text message may be automatically sent to a parker, which may comprise:
User name, phone number, and/or email address of owner
Reservation time during which parker has reserved parking spot
Phone number of a call center that may help mediate potential problems (e.g. parker can't find parking spot).
Amount of financial compensation due to the owner
Map of neighborhood of parking spot.
Driving directions to parking spot
Digital image of parking spot

Financial transfer may occur to compensate the owner for renting the parking spot to the parker. In one embodiment, the central server may accept a percentage of this compensation as a service fee. Compensation may be transferred in several ways (e.g. parker compensates central server and/or central server compensates owner. E.g. parker compensates owner.) Compensation may occur during or after every reservation, or compensation may occur after several transactions (e.g. after owner rents parking spot five times; e.g. once every month).

In one embodiment, it may be verified whether the parker and/or owner abide by the terms of the reservation. Financial transfer may occur only after this verification and/or penalties may be imposed to rectify or minimize problems. Customer care representatives may be available for mediation or rectifying problems (e.g. via call center or email). For example, it may be verified that:
The parking spot is available for parking as promised. If not, alternative parking may be found for the parker.
The parker parks in the parking spot only during the reservation time. If not, the parker may be towed.
Neither the parker nor the owner damage property of the other party. If damage occurs, legal ramifications may result for one of the parties.

In one embodiment, the parker may extend a reservation (e.g. by sending a text message to the central server), and potential conflicts with future parkers in parking spot may be redirected to alternative parking spots.)

### 6.5.1 Offers

Offers may or may not be provided to parkers. In one embodiment, an offer may be provided on behalf of a third party (e.g. a business that is 1) associated with the central server and 2) is located near the reserved parking spot).

An offer may comprise:
A benefit provided to the parker (e.g. coupon for free coffee, half-priced lunch, a super-size value meal)
A service may be provided on the parker's car while car is parked (e.g. auto repair shop may rotate tires or pick up car for oil-change and return to parking spot)
A benefit may be applied to parking (e.g. parker can park in coffee shop lot for 2 hours if he buys 1 large coffee; e.g. rental time may be extended or price may be discounted if you fulfill offer)
The offer may or may not be contingent upon fulfilling the terms of a parking reservation
An advertisement with no benefit provided to the parker
The offer may be valid with or without restrictions (e.g. only valid during time at which parking spot is being used; e.g. only valid if parker purchases a coffee at a store)
The parker may receive more than one offer

An offer may be targeted to a parker, based on one or more parameters associated with the parker or reservation. For example:
Time (e.g. if parking before noon, coffee shop offer is provided, else restaurant offer)
Location (e.g. Starbucks® offers are only provided to parkers who park within 4 blocks of the business)
Demographic information of the parker (e.g. bars advertised to parkers over 21 years old)
A combination of one or more of the parameters

Offers may be provided via, for example:
Text
Within a confirmation email
On a page of a website that a parker or owner has accessed
Any other means of communication

The third party may or may not compensate the central server in exchange for providing the offer to a parker. If there is compensation, it may be based on, for example:
A fixed compensation rate ($0.50 per parker) or variable compensation rate (e.g. $1 if parking spot is within 4 blocks of store, but $0.50 if parking spot is more than 4 blocks away)
Whether the offer is provided to the parker (e.g. in a confirmation email)
Whether the parker enters the store or fulfills the offer

In one embodiment, no service fee is charged by the central server to the parker or owner. For example, the central server may earn revenue solely from advertising. In another embodiment, revenue is earned by the central server from advertising and/or service fees charged to the parker and/or to the owner.

In one embodiment, the third party is the same party as the parking spot owner. For example, Creamy Donuts rents its parking spots during hours when it is closed, and it offers 1 free donut per month to anyone who rents one of its parking spots.

### 7.0 ALTERNATIVE IDEAS

### 7.1 Member Ratings

Parkers and owners (i.e. members) may be rated by other members and/or the central server based upon interactions. The ratings may help establish a sense of responsibility and community among members, as well as identify abusers or dependable members. Member ratings may influence:
whether an offer is provided (e.g. only parking spots with highly rated owners come with offers, or come with the most attractive offers.)
which offer is provided
which parking spots are presented to parkers after a search (e.g. owners' parking spots are provided only if owners have high member ratings. e.g. parkers with high member ratings have access to more parking spots. e.g. parkers and owners may specify that they will only do business with other members who have high ratings.)

Members with high ratings may also earn a benefit, such as free rental hours.

### 7.2 Frequent Member Program

Similar to rating members (Refer to Section 7.1), members may be distinguished from each other based on how often they rent parking spots and/or provide parking. (e.g. third parties pay central server more per offer if parker frequents area often, since frequent parkers have the potential to spend more money)

### 7.3 Redistribute Parkers

The central server may provide an offer or subsidize the cost of parking if the parker parks further away from desired location or in a specified parking spot. (e.g. parker wants to go to Kendall Square on Red T line in Cambridge, but parker is offered half-priced parking if he agrees to park in Harvard Square and take the T to Kendall Square.

Although the present invention has been described with respect to particular embodiments thereof, those skilled in the art will note that various substitutions may be made to those embodiments described herein without departing from the spirit and scope of the present invention.

What is claimed is:

1. A method, comprising:
receiving a request to identify at least one parking spot;
selecting at least one offer for a parker; and
providing an indication of the at least one offer.

2. The method of claim 1, wherein the at least one offer is associated with a third party.

3. The method of claim 1, wherein the at least one parking spot is at least one available parking spot.

4. The method of claim 3, further comprising:
receiving a timerange associated with the at least one available parking spot of at least one owner.

5. The method of claim 1, wherein the parameters, on which identification of the at least one parking spot is based, may comprise one or more of:
a timerange;
a reservation time;
a price;
a location;
a size of the parking spot;
a presence of a roof over the at least one parking spot;
a member rating of an owner;
a location of destination of the parker;
a location of the at least one parking spot;
an assessment of the safety of a neighborhood of the at least one parking spot;
an offer.

6. The method of claim 1, further comprising:
receiving an indication from the parker to reserve the at least one parking spot.

7. The method of claim 1, further comprising:
reserving the at least one parking spot for the parker.

8. The method of claim 7, further comprising:
receiving compensation from the third party in exchange for providing the offer to the parker.

9. The method of claim 1, wherein the method of providing the indication of the at least one offer to the parker may comprise one or more of:
a text message;
an E-mail;
a Web page;
an audio message;
a telephone call;
a non-electronic mode of communication.

10. The method of claim 1, wherein the information that the selection of the offer is based on comprises one or more of:
a reservation time;
a timerange;
a location of the parking spot;
a location of the third party;
a amount of compensation provided by the third party to a central server;
a member rating of the parker;
a frequency of participation in reservations by the parker;
a demographic information that is associated with the parker;
a preference of the third party.

11. The method of claim 1, wherein the at least one offer may comprise one or more of:
a benefit to the parker in exchange for redeeming a coupon to the third party;
a benefit to the parker with associated restrictions;
a benefit to the parker after fulfilling the terms of a reservation;
an advertisement that announces no associated benefit for the parker.

12. The method of claim 9, wherein the benefit may comprise one or more of:
a product;
a service;
a reduction in cost of a parking reservation.

13. A method, comprising:
providing at least one reservation time that is associated with at least one parking spot;
providing a location for the at least one parking spot;
receiving an indication that the at least one parking spot has been reserved by at least one parker, wherein at least one offer is associated with the at least one parker.

14. A transaction device, comprising:
a processor; and
a storage device coupled to the processor and storing instructions adapted to be executed by the processor to:
receive a request to identify at least one parking spot;
select at least one offer for a parker; and
provide an indication of the at least one offer.
